(19) United States
(12) Patent Application Publication
(10) Pub. No.: US 2026/0179551 A1
(43) Pub. Date: Jun. 25, 2026

(54) DISPLAY DEVICE AND DRIVING METHOD THEREOF

(71) Applicant: LG Display Co., Ltd., Seoul (KR)

(72) Inventors: Woo Kyu SANG, Paju-si (KR); Bo Gun SEO, Paju-si (KR); Moon Soo CHUNG, Paju-si (KR)

(73) Assignee: LG Display Co., Ltd., Seoul (KR)

(21) Appl. No.: 19/376,580

(22) Filed: Oct. 31, 2025

(30) Foreign Application Priority Data
Dec. 24, 2024 (KR) 10-2024-0195832

(51) Int. Cl. G09G 3/3233

(52) U.S. Cl. CPC G09G 3/3233; G09G 2300/043; G09G 2300/0819; G09G 2310/0245; G09G 2320/0247; G09G 2330/021

(57) ABSTRACT

A display device includes a display panel including one or more pixels and a display panel driver configured to, when performing a scene change from a previous image to a target image, repeatedly write target data, which is for implementing the target image, in a target pixel during a plurality of refresh frames continuously arranged, and then, hold the target data in the target pixel during a plurality of skip frames, wherein, in a first refresh frame immediately after the scene change among the plurality of refresh frames, pre-setting data corresponding to the target data is written in the target pixel a plurality of times before the target data is written in the target pixel.

### CROSS-REFERENCE TO RELATED APPLICATIONS

This application claims the benefit of the Korean Patent Application No. 10-2024-0195832 filed on Dec. 24, 2024, which is hereby incorporated by reference as if fully set forth herein.

### BACKGROUND

### Technical Field

The present disclosure relates to a display device and a driving method thereof.

### Discussion of the Related Art

Display devices include a plurality of pixels arranged as a matrix type and implement luminance corresponding to image data by using the pixels. In display devices, technology where a refresh rate varies based on an attribute of an image has been known. Variable refresh rate (VRR) technology increases a data refresh cycle as a variation of an image is reduced, and thus, decreases power consumption.

A data refresh operation is performed in a refresh frame and is not performed in a skip frame. As the number of skip frames provided between adjacent refresh frames increases, a data refresh cycle increases, and a low refresh rate (hereinafter referred to as an LRR) is implemented.

Due to flicker occurring when a gray level of an image varies in LRR driving, a scene change may be recognized to be unnatural by a viewer. Therefore, it is required to develop a method which prevents flicker caused by a scene change from being recognized.

### SUMMARY

Accordingly, embodiments of the present disclosure are directed to a display device and a driving method thereof that substantially obviates one or more of the problems due to limitations and disadvantages of the related art.

An aspect of the present disclosure is to provide a display device and a driving method thereof that may improve a flicker characteristic and may also minimize an increase in power consumption.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other aspects of the inventive concept, as embodied and broadly described herein, a display device comprises: a display panel including one or more pixels; and a display panel driver configured to, when performing a scene change from a previous image to a target image, repeatedly write target data, which is for implementing the target image, in a target pixel during a plurality of refresh frames continuously arranged, and then, hold the target data in the target pixel during a plurality of skip frames, wherein, in a first refresh frame immediately after the scene change among the plurality of refresh frames, pre-setting data corresponding to the target data is written in the target pixel a plurality of times before the target data is written in the target pixel.

In another aspect, a display device comprises: a display panel including one or more pixels; and a display panel driver configured to, when performing a scene change from a previous image to a target image, write target data, which is for implementing the target image, in a target pixel during a refresh frame, and then, hold the target data in the target pixel during a plurality of skip frames, wherein an initialization voltage for a reset operation is applied to the target pixel a plurality of times before the target data is written in the target pixel, in the refresh frame.

In another aspect, a pixel circuit comprises: a driving transistor comprising a gate electrode connected to a first node, a first electrode connected to a second node, and a second electrode connected to a third node; a first switching transistor comprising a first electrode connected to the first node, a second electrode connected to the third node, and a gate electrode receiving a first scan signal; a second switching transistor comprising a first electrode receiving data voltage, a second electrode connected to the second node, and a gate electrode receiving a second scan signal; a third switching transistor comprising a first electrode connected to a first power source voltage, a second electrode connected to the second node, and a gate electrode receiving an emission control signal; a fourth switching transistor comprising a first electrode connected to the third node, a second electrode connected to a fourth node, and a gate electrode receiving the emission control signal; a fifth switching transistor comprising a first electrode receiving an on bias stress (OBS) voltage, a second electrode connected to the second node, and a gate electrode receiving a third scan signal; a sixth switching transistor comprising a first electrode receiving an anode reset voltage, a second electrode connected to the fourth node, and a gate electrode receiving the third scan signal; a seventh switching transistor comprising a first electrode receiving an initialization voltage, a second electrode connected to the first node, and a gate electrode receiving a fourth scan signal; a capacitor connected between the first node and the first power source voltage; and a light emitting element comprising an anode electrode connected to the fourth node and a cathode electrode connected to a second power source voltage.

It is to be understood that both the foregoing general description and the following detailed description are exemplary and explanatory and are intended to provide further explanation of the inventive concepts as claimed.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description serve to explain various principles of the disclosure. In the drawings:

FIG. 1 is a diagram illustrating a display device according to an embodiment of the present disclosure;

FIG. 2 is a diagram illustrating an example of variable refresh rate (VRR) technology applied to a display device according to an embodiment of the present disclosure;

FIG. 3 is a diagram illustrating a pixel according to an embodiment of the present disclosure;

FIG. 4 is a driving waveform diagram of a pixel in a refresh frame;

FIG. 5 is a diagram showing a driving waveform of a pixel in a skip frame;

FIGS. 6 and 7 are diagrams illustrating a result obtained by comparing single refresh driving with multi-refresh driving when performing an LRR operation;

FIGS. 8 to 9C are diagrams illustrating a process where a middle peak luminance increases toward a target level through multi-refresh driving in first to third refresh frames immediately after a scene is changed;

FIGS. 10 to 13 are diagrams illustrating multi pre-setting driving applied in parallel with multi-refresh driving when performing an LRR operation;

FIG. 14 is a diagram illustrating multi pre-setting driving decoupled from EM ON driving;

FIG. 15 is a diagram illustrating multi pre-setting driving coupled to EM ON driving;

FIGS. 16A and 16B are diagrams illustrating ΔVth variation with respect to FIGS. 14 and 15;

FIGS. 17 to 19 are diagrams illustrating multi pre-setting driving coupled to Vini swing driving;

FIG. 20 is a diagram illustrating multi pre-setting driving coupled to OBS ON driving;

FIG. 21 is a diagram illustrating multi pre-setting driving coupled to OBS OFF driving; and

FIGS. 22 and 23 are diagrams illustrating multi pre-setting driving requiring no parallel with multi-refresh driving.

### DETAILED DESCRIPTION

Hereinafter, the present disclosure will be described more fully with reference to the accompanying drawings, in which exemplary embodiments of the disclosure are shown. The disclosure may, however, be embodied in many different forms and should not be construed as being limited to the embodiments set forth herein; rather, these embodiments are provided so that this disclosure will be thorough and complete, and will fully convey the concept of the disclosure to those skilled in the art.

Advantages and features of the present disclosure, and implementation methods thereof will be clarified through following embodiments described with reference to the accompanying drawings. The present disclosure may, however, be embodied in different forms and should not be construed as limited to the embodiments set forth herein. Rather, these embodiments are provided so that this disclosure will be thorough and complete, and will fully convey the scope of the present disclosure to those skilled in the art. Furthermore, the present disclosure is only defined by scopes of claims.

The shapes, sizes, ratios, angles, numbers and the like disclosed in the drawings for description of various embodiments of the present disclosure to describe embodiments of the present disclosure are merely exemplary and the present disclosure is not limited thereto. Like reference numerals refer to like elements throughout. Throughout this specification, the same elements are denoted by the same reference numerals. As used herein, the terms “comprise”, “having,” “including” and the like suggest that other parts can be added unless the term “only” is used. As used herein, the singular forms “a”, “an”, and “the” are intended to include the plural forms as well, unless context clearly indicates otherwise.

Elements in various embodiments of the present disclosure are to be interpreted as including margins of error even without explicit statements.

In describing a position relationship, for example, when a position relation between two parts is described as “on˜”, “over˜”, “under˜”, and “next˜”, one or more other parts may be disposed between the two parts unless “just” or “direct” is used.

It will be understood that, although the terms “first”, “second”, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure.

In the following description, when the detailed description of the relevant known function or configuration is determined to unnecessarily obscure the important point of the present disclosure, the detailed description will be omitted. Hereinafter, embodiments of the present disclosure will be described in detail with reference to the accompanying drawings.

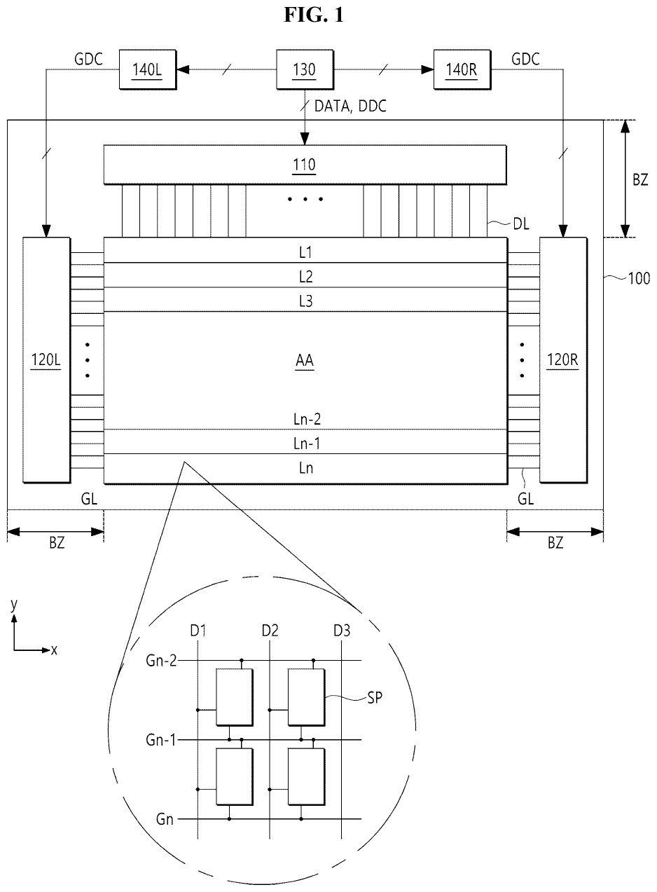

FIG. 1 is a diagram illustrating a display device according to an embodiment of the present disclosure.

Referring to FIG. 1, the display device according to an embodiment of the present embodiment may be an organic light emitting display device, but is not limited thereto. A display panel 100 may include a screen AA which reproduces an input image. The screen AA may include a pixel array which displays pixel data (hereinafter referred to as “image data”) DATA of an input image. The pixel array may include a plurality of data lines DL, a plurality of gate lines GL intersecting with the data lines DL, and a plurality of pixels SP.

The pixels SP may be arranged on the screen AA in a matrix type defined by intersections between the data lines DL and the gate lines GL. The pixels SP may be arranged as various types such as a stripe type and a diamond type on the screen AA, based on positions of the pixels SP emitting lights of the same color.

The pixel array may include a plurality of pixel columns and a plurality of pixel rows L1 to Ln intersecting the pixel columns. Each of the pixel columns may include pixels SP which are arranged in a Y-axis direction. A pixel row may include pixels SP which are arranged in an X-axis direction. One vertical period may be one frame period needed for writing image data DATA of one frame in all pixels of the screen. One horizontal period may be a time obtained by dividing one frame period by the number of pixel rows L1 to Ln. One horizontal period may be a time needed for writing the image data DATA of one pixel row, sharing a gate line GL, in pixels SP of one pixel row.

The pixels SP may include a first pixel which generates red (R) light, a second pixel which generates green (G) light, and a third pixel which generates blue (B) light, for various color combinations. The pixels SP may further include a fourth pixel which generates white (W) light. The first to third pixels or the first to fourth pixels may configure one unit pixel.

Each of the pixels SP may be implemented with a pixel circuit connected to a data line DL and a gate line GL. The pixel circuit may include a light emitting element, a driving transistor, one or more switch transistors, and a capacitor. The light emitting element may be implemented as an organic light emitting diode (OLED). A driving current applied to the light emitting element may be controlled based on a gate-source voltage of the driving transistor. The gate-source voltage of the driving transistor may be determined by a data voltage corresponding to the image data DATA. In FIG. 1, “D1 to D3” illustrated in a circle may be data lines, and “Gn-2 to Gn” may be gate lines. Each of the pixels SP of FIG. 1 may be further connected to a front-end gate line as well as a current-end gate line. For example, each of pixels SP disposed in an n^{th} pixel row Ln may be connected to a front-end gate line Gn-1 as well as an n^{th} gate line Gn.

The pixel circuit may sample a threshold voltage of the driving transistor in the middle of a pixel programming operation which is performed in one frame period and may allow a sampled threshold voltage to be reflected in a gate-source voltage (hereinafter referred to as Vgs) of the driving transistor, and thus, may prevent a driving current from being distorted due to a threshold voltage variation of the driving transistor.

The pixel circuit may be implemented as a hybrid type. In a hybrid-type pixel circuit, semiconductor layers of some transistors may include low-temperature polycrystalline silicon (hereinafter referred to as LTPS), and semiconductor layers of the other transistors may be configured with oxide.

The pixel circuit may be driven based on variable refresh rate (VRR) technology. To implement the VRR variable technology, one or more skip frames may be provided between adjacent refresh frames. A refresh rate (i.e., a frame frequency) may be determined based on the number of skip frames provided between adjacent refresh frames.

A data refresh operation including pixel initialization and data programming may be performed in a refresh frame. The light emitting element may be turned off when performing a data refresh operation, and at this time, an anode reset operation where the light emitting element is initialized into an anode reset voltage may be performed.

A data refresh operation on the pixels SP may be omitted (or skipped) in a skip frame, and a data refresh condition Vgs (the driving current) which is set in the refresh frame may be maintained. An anode reset operation for turning off the light emitting element may be performed in the skip frame. Accordingly, a time length where the light emitting element is turned on in the skip frame may be substantially equal to a time length where the light emitting element is turned on in the refresh frame.

In each of the refresh frame and the skip frame, while the anode reset operation is being performed, an on-bias stress (OBS) operation may be performed on the driving transistor.

In the hybrid-type pixel circuit according to the present embodiment, the OBS operation may be for preventing an image quality degradation caused by a hysteresis characteristic of the driving transistor. When a grayscale value of the image data DATA is changed from black to white, a grayscale response time may increase in a first frame where a white image is reproduced, due to a time needed for varying the hysteresis characteristic of the driving transistor, and thus, a dim first frame (DFF) phenomenon may occur. At this time, when the Vgs of the driving transistor is increased by applying an OBS voltage to one electrode of the driving transistor, a DFF characteristic may be alleviated. This may be referred to as an OBS operation.

Touch sensors may be further disposed on the display panel 100. The touch sensors may be arranged as an on-cell or add-on type on the screen AA of the display panel 100, or may be implemented as in-cell type touch sensors embedded in the pixel array. A touch input may be sensed through only the pixels SP even without the touch sensors, and in this case, the touch sensors may be omitted.

A display panel driver may include a source driver 110 and gate drivers 120L and 120R. The display panel driver may write the image data DATA in the pixels SP of the display panel 100, based on control by a timing controller 130.

A source driver 110 may convert the image data DATA, received from the timing controller 130, into gamma compensation voltages by using a digital-to-analog converter (DAC) to generate data voltages. The source driver 110 may supply the data voltages to the data lines DL. The data voltages may be supplied to the data lines DL and may be applied to gate electrodes of the driving transistors through the switch transistors of the pixels SP. The source driver 110 may be implemented with a plurality of source drive integrated circuits (ICs).

To reduce an RC delay deviation occurring in the display panel 100 including a large screen, the gate drivers 120L and 120R may be implemented as a double bank type. That is, the gate drivers 120L and 120R may be provided as a gate driver in panel (GIP) type in left and right bezel regions BZ disposed outside the screen AA of the display panel 100 and may supply gate signals having the same phase to the same gate line GL at both sides of the display panel 100. The gate drivers 120L and 120R may include a first-side gate driver 120L which is disposed in the left bezel region BZ of the display panel 100 and a second-side gate driver 120R which is disposed in the right bezel region BZ of the display panel 100.

The gate drivers 120L and 120R at both sides may sequentially supply a gate signal to the gate lines GL, based on control by the timing controller 130. The gate signal may select pixel rows L1 to Ln charged with data voltages and may simultaneously activate pixels SP disposed in corresponding pixel rows L1 to Ln. The gate drivers 120L and 120R may output a gate signal needed for pixel driving and may shift the gate signal by pixel row units. The gate signal may include a plurality of scan signals which swing between an on level and an off level and an emission control signal. The gate drivers 120L and 120R at both sides may include a plurality of scan drivers which generate a plurality of scan signals and an emission driver which generates an emission control signal.

In the left and right bezel regions BZ, a below-described OBS control circuit and the gate drivers 120L and 120R may configure a GIP circuit block. The OBS control circuit may shift an OBS voltage from a first level to a second level differing from the first level in a refresh frame, and thus, may improve a flicker characteristic and may enhance low grayscale expression. An OBS control operation may be performed with respect to an output of one of the plurality of scan drivers. This will be described below in detail.

The timing controller 130 may receive video data DATA and a timing signal, synchronized with the video data DATA, from a host system (not shown). The timing signal may include a vertical synchronization signal Vsync, a horizontal synchronization signal Hsync, a clock signal DCLK, and a data enable signal DE. The vertical synchronization signal Vsync may define a vertical period. The horizontal synchronization signal Hsync may define a horizontal period. The data enable signal DE may define a time where the video data DATA is transferred, in a vertical period or a horizontal period. The vertical period and the horizontal period may be determined by a method of counting the data enable signal DE, and thus, the vertical synchronization signal Vsync and the horizontal synchronization signal Hsync may be omitted.

The timing controller 130 may generate a source timing control signal DDC for controlling an operation timing of the source driver 110 and a gate timing control signal GDC for controlling an operation timing of the gate drivers 120L and 120R, based on the timing signal Vsync, Hsync, and DE received from the host system.

The host system may be one of a television (TV), a set-top box, a navigation system, a personal computer (PC), a home theater, an automotive display system, a mobile device, and a wearable device. In the mobile device and the wearable device, the source driver 110, the timing controller 130, and level shifters 140L and 140R may be integrated into one drive IC.

The level shifters 140L and 140R may convert a voltage of the gate timing control signal GDC, output from the timing controller 130, into an on-level voltage and an off-level voltage and may supply the on-level voltage and the off-level voltage to the gate drivers 120L and 120R.

The level shifters 140L and 140R may include a first level shifter 140L which is connected to the first-side gate driver 120L through first signal lines and a second level shifter 140R which is connected to the second-side gate driver 120R through second signal lines.

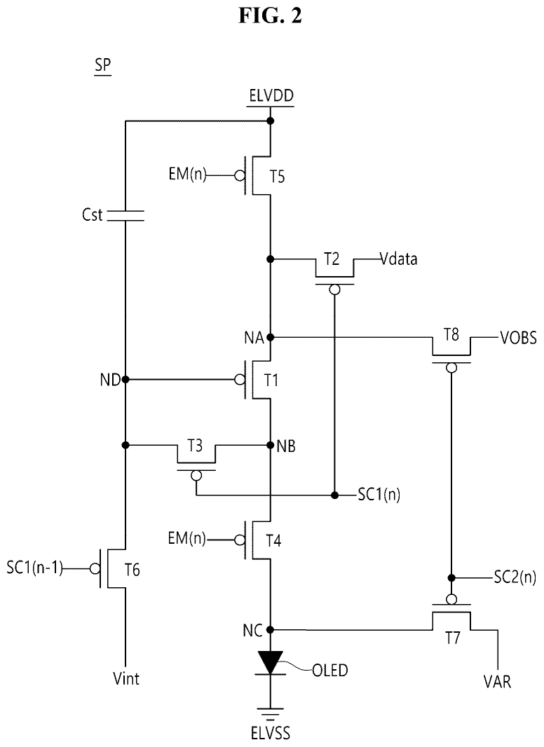

FIG. 2 is a diagram illustrating an example of VRR technology applied to a display device according to an embodiment of the present disclosure.

Referring to FIG. 2, a data refresh cycle implemented in pixels of a display panel may vary based on an attribute of an input image. The data refresh cycle may decrease when the amount of variation of an image is large, and when the amount of variation of the image is small, the data refresh cycle may increase. As the data refresh cycle increases, low-speed driving may be performed, and as the data refresh cycle decreases, high-speed driving may be performed.

The data refresh cycle may be 1/frame frequency. For example, the data refresh cycle may be 1 sec/120 when the frame frequency is 120 Hz, be 1 sec/60 when the frame frequency is 60 Hz, be 1 sec/24 when the frame frequency is 24 Hz, and be 1 sec when the frame frequency is 1 Hz.

The number of skip frames provided between two adjacent refresh frames may vary based on a frame frequency. For example, the number of skip frames may be 0 when the frame frequency is 120 Hz, be 1 when the frame frequency is 60 Hz, be 4 when the frame frequency is 24 Hz, and be 119 when the frame frequency is 1 Hz.

Due to a leakage characteristic variation occurring in pixels, a luminance deviation between frames may occur. Such a luminance deviation is more noticeable in low-speed driving where a data refresh cycle is long, and due to this, a flicker characteristic may be degraded (i.e., the amount of flickers may increase).

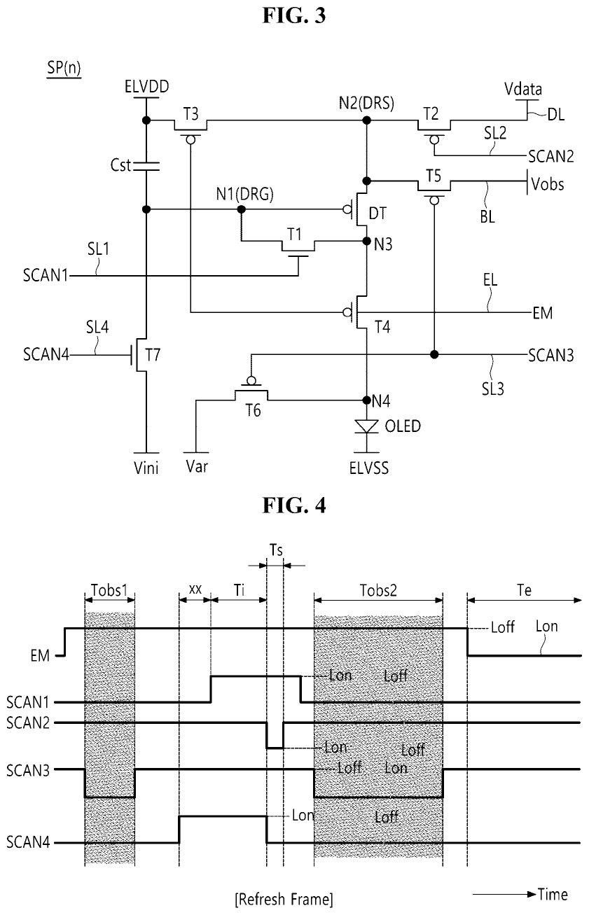

FIG. 3 is a diagram illustrating a pixel SP disposed in an n^{th} pixel row Ln according to an embodiment of the present disclosure.

Referring to FIG. 3, the pixel SP disposed in the n^{th} pixel row Ln may be implemented with a pixel circuit which includes a light emitting element OLED, a driving transistor DT, a plurality of switch transistors (for example, first to seventh switch transistors) T1 to T7, and a capacitor Cst.

The driving transistor DT, the switch transistors T1 to T7, and the capacitor Cst may control a driving current flowing in the light emitting element OLED to drive the light emitting element OLED. Each of the driving transistor DT and the switch transistors T1 to T7 may include a first electrode, a second electrode, and a gate electrode. One of the first electrode and the second electrode may be a source electrode, and the other of the first electrode and the second electrode may be a drain electrode.

Each of the second to sixth transistors T2 to T6 and the driving transistor DT may be implemented as a PMOS type including a semiconductor layer having LTPS, which is good in response characteristic. On the other hand, the first and seventh transistors T1 and T7 connected to a gate electrode of the driving transistor DT may be implemented as an NMOS type including an oxide semiconductor layer which is good in off characteristic.

An on level voltage of the PMOS-type transistor may be a gate low voltage, and an off level voltage may be a gate high voltage. On the other hand, an on level voltage of the NMOS-type transistor may be a gate high voltage, and an off level voltage may be a gate low voltage.

The light emitting element OLED may include an anode electrode (or a pixel electrode), a cathode electrode (or a common electrode), and an organic compound layer (configured with a common layer and an emission layer) disposed therebetween. The anode electrode of the light emitting element OLED may be connected to a fourth node N4, and the cathode electrode of the light emitting element OLED may be connected to a second power source voltage ELVSS.

The driving transistor DT may include a gate electrode connected to the first node N1, a source electrode connected to a second node N2, and a drain electrode connected to a third node N3. The driving transistor DT may generate the driving current based on a voltage of the first node N1 (or a data voltage stored in the capacitor Cst) and may apply the driving current to the light emitting element OLED.

The first switch transistor T1 may include a gate electrode receiving a first scan signal SCAN1 through a first scan line SL1, a drain electrode connected to the third node N3, and a source electrode connected to the first node N1. The first switch transistor T1 may be turned on in response to the first scan signal SCAN1 and may short-circuit the gate electrode and the drain electrode of the driving transistor DT with each other. Accordingly, the driving transistor DT may operate like a diode while the first switch transistor T1 is being turned on.

The second switch transistor T2 may include a gate electrode receiving a second scan signal SCAN2 through a second scan line SL2, a source electrode connected to a data line (or receiving a data voltage Vdata), and a drain electrode connected to the second node N2. The second switch transistor T2 may be turned on in response to the second scan signal SCAN2 and may transfer the data voltage Vdata to the second node N2.

The capacitor Cst may be connected between the first node N1 and an input terminal of the first power source voltage ELVDD. The capacitor Cst may hold a voltage of the first node N1.

The third and fourth switch transistors T3 and T4 may be connected between the first power source voltage ELVDD and the light emitting diode OLED and may form a current movement path through which the driving current generated by the driving transistor DT moves.

The third switch transistor T3 may include a source electrode connected to the input terminal of the first power source voltage ELVDD, a drain electrode connected to the second node N2, and a gate electrode which receives an emission control signal EM through an emission control line EL. The fourth switch transistor T4 may include a source electrode connected to the third node N3, a drain electrode connected to the fourth node N4, and a gate electrode which receives the emission control signal EM through the emission control line EL.

The third and fourth switch transistors T3 and T4 may be turned on in response to the emission control signal EM. While the third and fourth switch transistors T3 and T4 are being turned on, the light emitting element OLED may receive the driving current from the driving transistor DT and may emit light with brightness corresponding to the driving current.

The fifth switch transistor T5 may include a source electrode connected to an input terminal of an OBS voltage Vobs, a second electrode connected to the second node N2, and a gate electrode which receives a third scan signal SCAN3 through a third scan line SL3. The fifth switch transistor T5 may be turned on in response to the third scan signal SCAN3 and may apply the OBS voltage Vobs to the second node N2.

The sixth switch transistor T6 may include a source electrode connected to an input terminal of an anode reset voltage Var, a drain electrode connected to the fourth node N4, and a gate electrode which receives the third scan signal SCAN3 through the third scan line SL3. The sixth switch transistor T6 may be turned on in response to the third scan signal SCAN3 and may transfer the anode reset voltage Var to the fourth node N4.

The seventh switch transistor T7 may include a source electrode connected to an input terminal of an initialization voltage Vini, a second electrode connected to the first node N1, and a gate electrode which receives a fourth scan signal SCAN4 through a fourth scan line SL4. The seventh switch transistor T7 may be turned on in response to the fourth scan signal SCAN4 and may apply the initialization voltage Vini to the first node N1.

FIG. 4 is a driving waveform diagram of a pixel in a refresh frame.

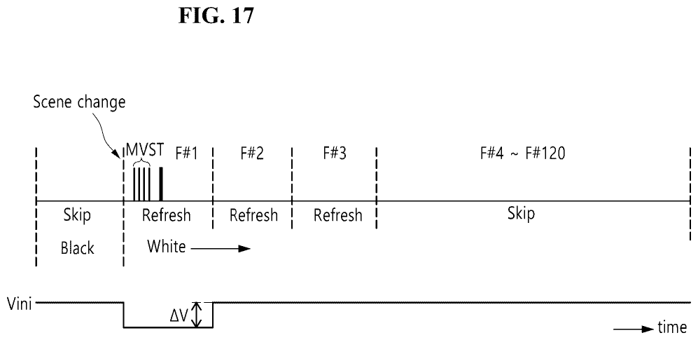

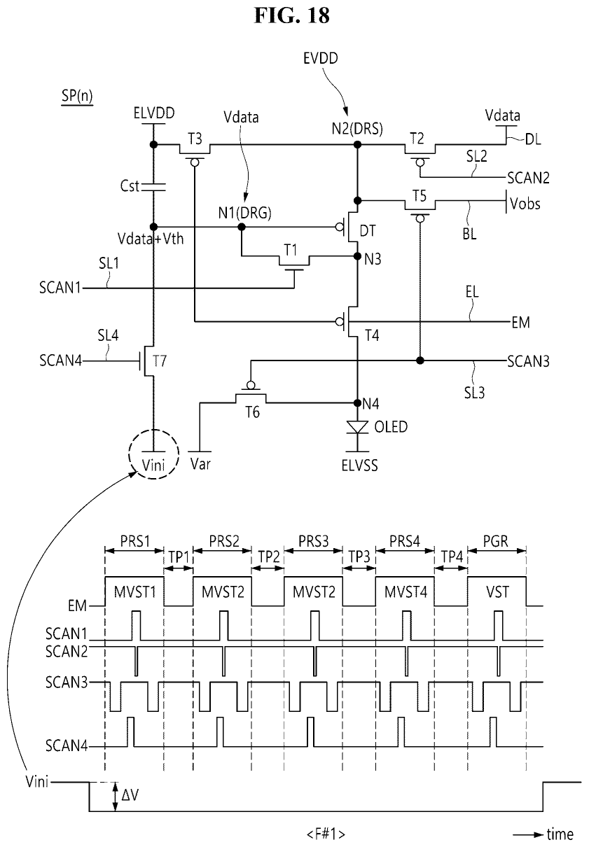

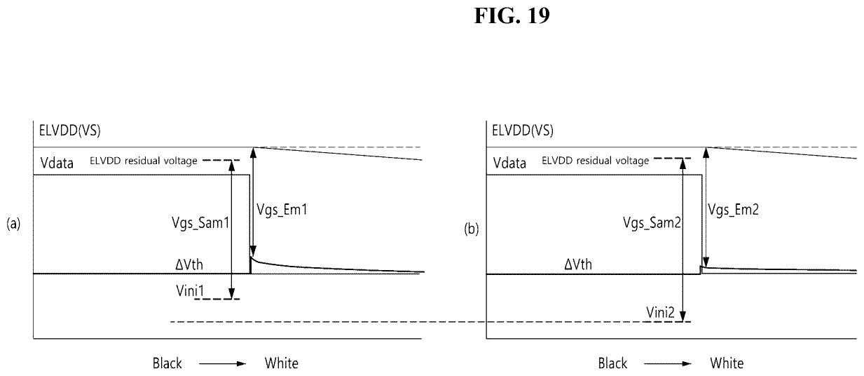

Referring to FIG. 4, a first OBS period Tobs1, an initialization period Ti, a programming period Ts, a second OBS period Tobs2, and an emission period Te may be time-serially arranged in the refresh frame. In FIG. 4, xx may represent a pre-OBS period. This will be described below in describing embodiments of FIGS. 17 to 19.

The second scan signal SCAN2 may define the programming period Ts where a data voltage Vdata is supplied. The programming period Ts may be an on level (Lon) period of a second scan signal SCAN2.

The third scan signal SCAN3 may define a first OBS period Tobs1 preceding the programming period Ts and a second OBS period Tobs2 succeeding the programming period Ts and preceding the emission period Te. The first OBS period Tobs1 and the second OBS period Tobs2 may each be an on level (Lon) period of the third scan signal SCAN3.

The fourth scan signal SCAN4 may define an initialization period Ti which is arranged between the first OBS period Tobs1 and the programming period Ts. The initialization period Ti may be an on level (Lon) period of the fourth scan signal SCAN4.

The emission control signal EM may define an emission period Te succeeding the second OBS period Tobs2. The emission period Te may be an on level (Lon) period of the emission control signal EM.

Referring to FIGS. 3 and 4, in the first OBS period Tobs1, in response to the third scan signal SCAN3, the fifth and sixth switch transistors T5 and T6 may be turned on, and the other switch transistors T1 to T4 and T7 may be turned off.

In the first OBS period Tobs1, as the fifth switch transistor T5 is turned on, the OBS voltage Vobs may be applied to the second node N2. Based on the OBS voltage Vobs, a drain-source channel of the driving transistor DT may be maximally opened, and the driving transistor DT may maintain a stronger saturation state, and thus, a hysteresis characteristic of the driving transistor DT may be recovered prior to data programming.

In the first OBS period Tobs1, as the sixth switch transistor T6 is turned on, the anode reset voltage Var may be applied to the fourth node N4. Based on the anode reset voltage Var, residual electric charges charged in a parasitic capacitor formed between the anode electrode and the cathode electrode of the light emitting element OLED may be reset.

Referring to FIGS. 3 and 4, in the initialization period Ti, in response to the first scan signal SCAN1 and the fourth scan signal SCAN4, the first and seventh switch transistors T1 and T7 may be turned on, and the other switch transistors T2 to T6 may be turned off. As the seventh switch transistor T7 is turned on, the first node N1 may be initialized into the initialization voltage Vini, and as the first switch transistor T1 is turned on, the driving transistor DT may operate like a diode.

Referring to FIGS. 3 and 4, in the programming period Ts, as the first and second switch transistors T1 and T2 are turned on, a threshold voltage sampling operation and a data programming operation may be sequentially or simultaneously performed.

The data voltage Vdata may be applied to the second node N2 through the second switch transistor T2. The data voltage Vdata may be applied to the third node N3 through the driving transistor DT, and then, may be applied to the first node N1 through the first switch transistor T1. The driving transistor DT may operate like a diode in a state where the first switch transistor T1 is turned on, an electric potential at the gate electrode of the driving transistor DT connected to the first node N1 may be programmed to be “Vdata−|Vth|”. A threshold voltage Vth may be sampled and reflected in a programmed electric potential at the gate electrode of the driving transistor DT.

Referring to FIGS. 3 and 4, in the second OBS period Tobs2, in response to the third scan signal SCAN3, the fifth and sixth switch transistors T5 and T6 may be turned on, and the other switch transistors T1 to T4 and T7 may be turned off.

In the second OBS period Tobs2, as the fifth switch transistor T5 is turned on, the OBS voltage Vobs may be applied to the second node N2. Based on the OBS voltage Vobs, a drain-source channel of the driving transistor DT may be maximally opened, and the driving transistor DT may maintain a stronger saturation state, and thus, a hysteresis characteristic of the driving transistor DT may be re-recovered prior to the emission of light.

In the second OBS period Tobs2, as the sixth switch transistor T6 is turned on, the anode reset voltage Var may be applied to the fourth node N4, and thus, residual electric charges charged in a parasitic capacitor of the light emitting element OLED may be re-reset.

Referring to FIGS. 3 and 4, in the emission period Te, in response to the emission control signal EM, the third and fourth switch transistors T3 and T4 may be turned on, and the other switch transistors T1, T2, T5, T6, and T7 may be turned off.

In the emission period Te, a driving current supplied from the driving transistor DT to the light emitting element OLED may be based on Vgs of the driving transistor DT set in the programming period Ts. The driving current may be irrelevant to a threshold voltage of the driving transistor DT and may be associated with the data voltage Vdata.

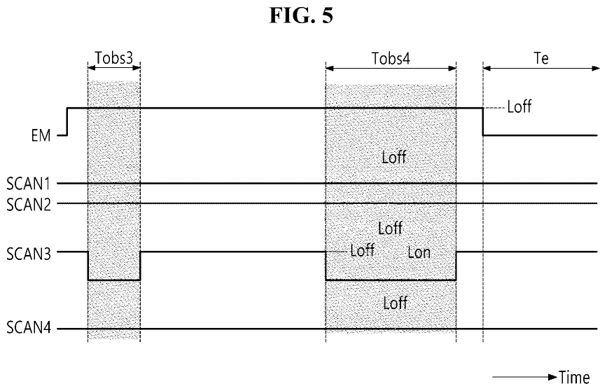

FIG. 5 is a diagram showing a driving waveform of a pixel in a skip frame.

Referring to FIG. 5, a third OBS period Tobs3, a fourth OBS period Tobs4, and an emission period Te may be time-serially arranged in the skip frame.

The emission control signal EM may define the emission period Te of the skip frame. An on level (Lon) period of the emission control signal EM in the skip frame may be substantially the same as the refresh frame.

The third scan signal SCAN3 may further define the third OBS period Tobs3 and the fourth OBS period Tobs4 which are sequentially arranged before the emission period Te, in the skip frame. In the skip frame, the third OBS period Tobs3 and the fourth OBS period Tobs4 may each be an on level (Lon) period of the third scan signal SCAN3.

Furthermore, the initialization period and the programming period may not be needed in the skip frame.

Referring to FIGS. 3 and 5, a hysteresis characteristic of the driving transistor DT may be re-recovered in the third OBS period Tobs3 and the fourth OBS period Tobs4, and thus, a hysteresis characteristic deviation between the skip frame and the refresh frame may be considerably reduced.

The first and second OBS periods Tobs1 and Tobs2 of the refresh frame may be included in an off level (Loff) period of the emission control signal EM, and moreover, the third and fourth OBS periods Tobs3 and Tobs4 of the skip frame may be included in the off level (Loff) period of the emission control signal EM.

A length of the off level (Loff) period of the emission control signal EM may be equal to each other in the refresh frame and the skip frame, and thus, a length of an emission maintenance time may be equal to each other in the refresh frame and the skip frame.

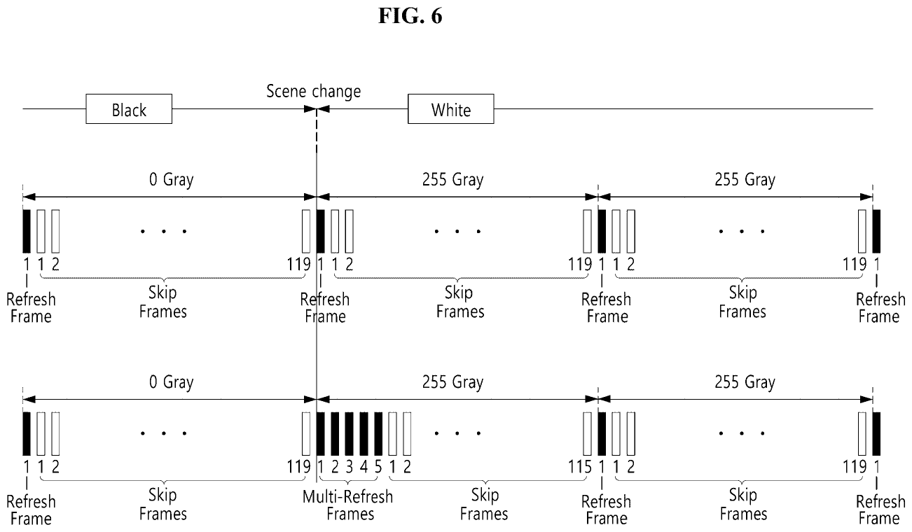

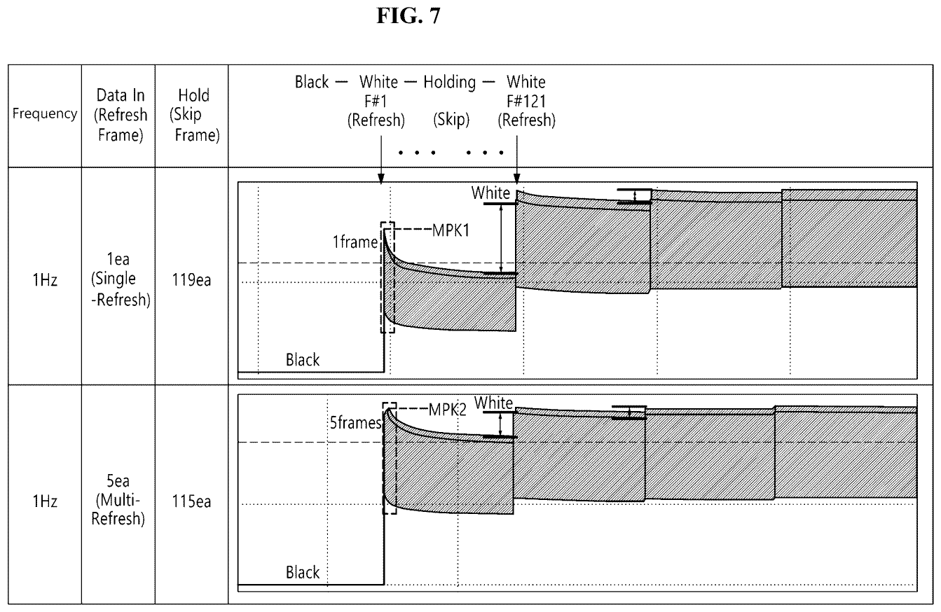

FIGS. 6 and 7 are diagrams illustrating a result obtained by comparing single refresh driving with multi-refresh driving when performing a low refresh rate (LRR) operation.

When an LRR operation is operating, a data hold period after a data refresh operation for a scene change (for example, Black to White) may be long maintained. According to single refresh driving, when changing a scene, a display luminance may not quickly increase up to a target level, and a stabilization time may increase, whereby flicker may be recognized.

For example, as shown in the upper portion of FIG. 6, a refresh frame may be arranged as one at a time at which a scene change occurs from a black gray level to a white gray level, and subsequently, when 119 skip frames are arranged, as shown in the upper portion of FIG. 7, a delay may occur in reaching a target level (i.e., a white gray level) from a display luminance. When changing a scene, the display luminance may increase up to a middle peak luminance MPK1 and may then be decayed, but because a difference between the target level and the middle peak luminance MPK1 is large, a stabilization time may increase.

On the other hand, multi-refresh driving according to an embodiment of the present disclosure may denote that an LRR operation is not intactly maintained at a time at which a scene change occurs, and a plurality of refresh frames are temporarily and continuously arranged. Accordingly, a time for which the display luminance reaches the target level may be shortened when changing a scene (for example, Black to White), under an LRR driving condition.

That is, when refresh driving is performed, a plurality of refresh frames having the same image data may be repeatedly arranged when changing a scene, and thus, a time for which the display luminance reaches the target level may be reduced in LRR driving, and an abnormal phenomenon such as flicker may be minimized.

For example, as shown in the lower portion of FIG. 6, five refresh frames may be continuously arranged at a time at which a scene change occurs from a black gray level to a white gray level, and subsequently, when 115 skip frames are arranged, as shown in the lower portion of FIG. 7, a time for which a display luminance reaches a target level (i.e., a white gray level) may be shortened. When changing a scene, the display luminance may increase up to a middle peak luminance MPK2 and may then be decayed, but because a difference between the target level and the middle peak luminance MPK2 is small, a stabilization time may be shortened.

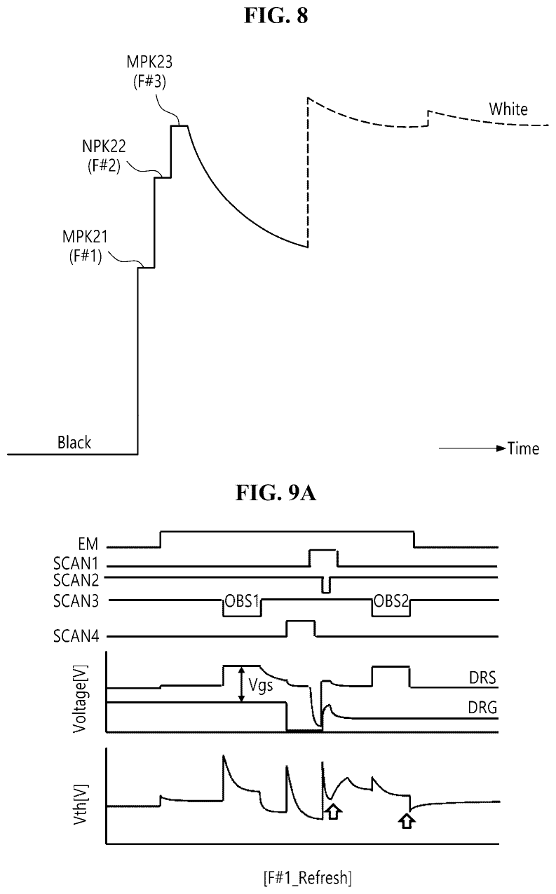

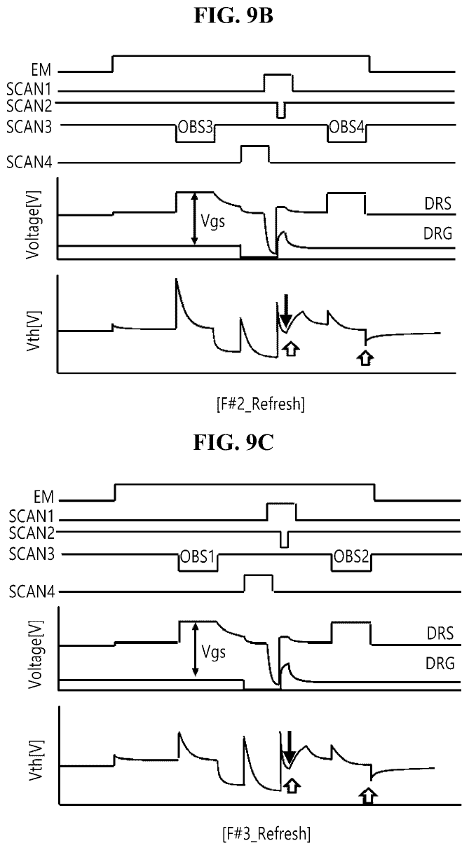

FIGS. 8 to 9C are diagrams illustrating a process where a middle peak luminance increases toward a target level through multi-refresh driving in first to third refresh frames immediately after a scene is changed.

Referring to FIGS. 3, 8, and 9A, a gate voltage of the driving transistor DT may be high with respect to a black gray level in a first refresh frame F #1. In OBS1 driving, a voltage difference (hereinafter referred to as Vgs) between the gate and the source of the driving transistor DT may be small, and thus, |Vth| may be small when sampling a threshold voltage Vth. On the other hand, in OBS2 driving, an OLED may emit light after a Vgs operation with respect to a white gray level, and thus, |Vth| may increase. As a result, in the first refresh frame F #1, due to a large Vth difference between a threshold voltage sampling time and an OLED emission time, a middle peak luminance may have a first level MPK21.

Referring to FIGS. 3, 8, and 9B, a gate voltage of the driving transistor DT may be low with respect to a white gray level in a second refresh frame F #2. In OBS1 driving, a Vgs of the driving transistor DT may increase, and thus, |Vth| may increase when sampling a threshold voltage Vth. Also, in OBS2 driving, an OLED may emit light after a Vgs operation with respect to a white gray level, and thus, |Vth| may increase. As a result, in the second refresh frame F #2, due to a small Vth difference between a threshold voltage sampling time and an OLED emission time, a middle peak luminance may have a second level MPK22 which is greater than the first level MPK21.

Referring to FIGS. 3, 8, and 9C, a gate voltage of the driving transistor DT may be very low with respect to a white gray level in a third refresh frame F #3. In OBS1 driving, a Vgs of the driving transistor DT may increase, and thus, |Vth| may increase when sampling a threshold voltage Vth. Also, in OBS2 driving, an OLED may emit light after a Vgs operation with respect to a white gray level, and thus, |Vth| may increase. As a result, in the third refresh frame F #3, due to a very small Vth difference between a threshold voltage sampling time and an OLED emission time, a middle peak luminance may have a third level MPK23 which is greater than the second level MPK22.

As described above, the display panel driver according to an embodiment of the present disclosure may repeatedly write target data, which is for implementing a target image at a scene change time from a previous image to a target image, in a target pixel during a plurality of refresh frames which are continuously arranged. Also, the target pixel may hold the target data during a plurality of skip frames.

According to the multi-refresh driving, a middle peak luminance may increase toward a target level in a plurality of refresh frames which are continuously arranged, and thus, a flicker characteristic may be improved, but a side effect may occur where power consumption increases due to an increase in number of refresh frames.

Hereinafter, additional embodiments for improving a flicker characteristic and minimizing an increase in power consumption will be described.

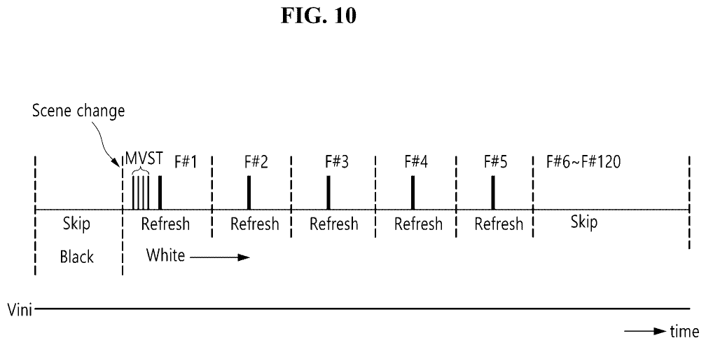

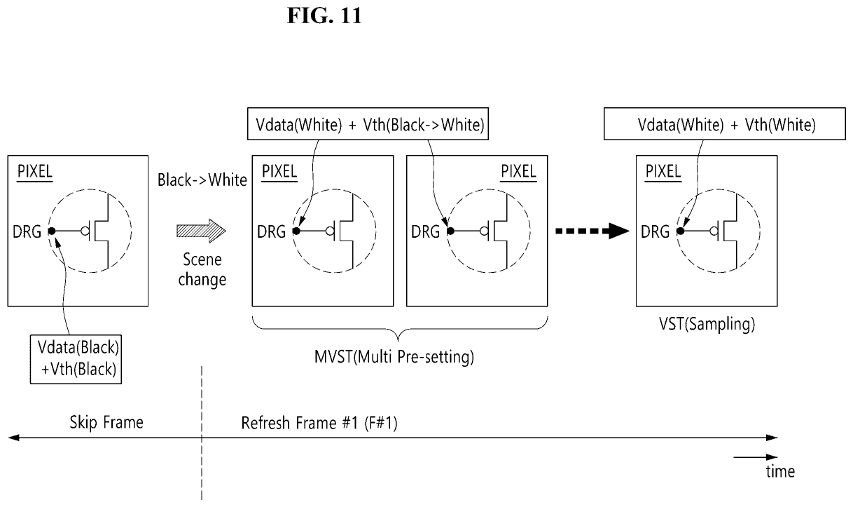

FIGS. 10 to 13 are diagrams illustrating multi pre-setting driving applied in parallel with multi-refresh driving when performing an LRR operation.

Referring to FIGS. 10 to 13, in addition to refresh driving, multi pre-setting driving (MVST) may be further applied for improving a flicker characteristic and minimizing an increase in power consumption. When the MVST is further applied, the number of refresh frames for multi-refresh driving may be reduced, and thus, a flicker characteristic may be improved, and an increase in power consumption may be minimized.

The MVST may be applied to only a first refresh frame F #1 immediately after a scene change among a plurality of refresh frames. According to the MVST, pre-setting data corresponding to target data may be first written in a target pixel repeatedly a plurality of times before the target data for implementing a target image is written in the target pixel, and thus, a Vth characteristic may be quickly changed based on the target data when performing threshold voltage sampling (VST) after multi pre-setting. The pre-setting data may be a voltage similar to the target data. For example, when a scene change is performed from a black gray level to a white gray level, the target data and the pre-setting data may represent a white gray level.

To change a Vth characteristic of a driving transistor needed for a scene change during the first refresh frame F #1, MVST may implement an operation similar to sampling by using pre-setting data which is target data of each of pre-charging pixels driven prior to a target pixel in the first refresh frame F #1.

When a scene change is performed from a black gray level to a white gray level, a Vth characteristic of a driving transistor may be gradually changed from a black gray level to a white gray level through MVST, and thus, a Vth characteristic may be quickly changed based on a white gray level when performing VST (the sampling of the threshold voltage).

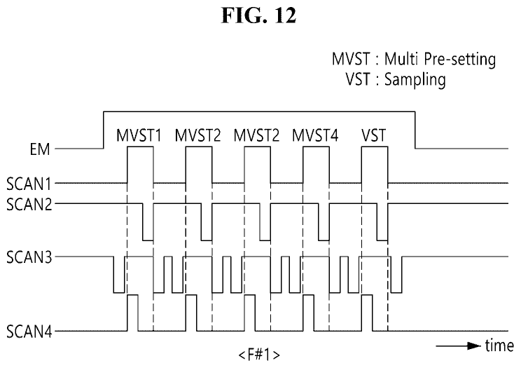

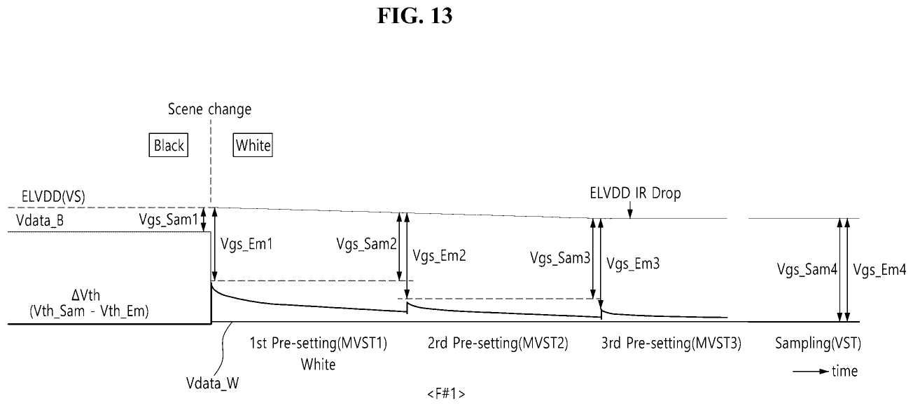

Referring to FIGS. 12 and 13, during the first refresh frame F #1, MVST may be repeated four times prior to VST.

As MVST proceeds from MVST1 to MVST4, a Vth difference ΔVth between a threshold voltage sampling time and an OLED emission time may be reduced, and thus, a middle peak luminance may increase toward a white gray level. Accordingly, a high-level pixel power ELVDD and a Vth characteristic may be stabilized in a VST step. Also, even when the number of refresh frames for multi-refresh driving is reduced (i.e., decreases by one compared to five frames of FIGS. 6 and 7), a peak luminance may be improved, and thus, an increase in power consumption caused by multi-refresh driving may be minimized.

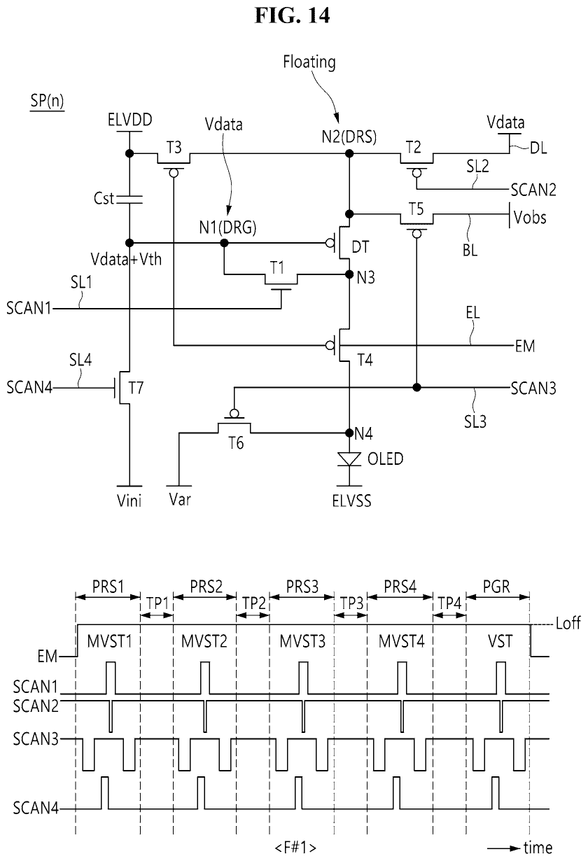

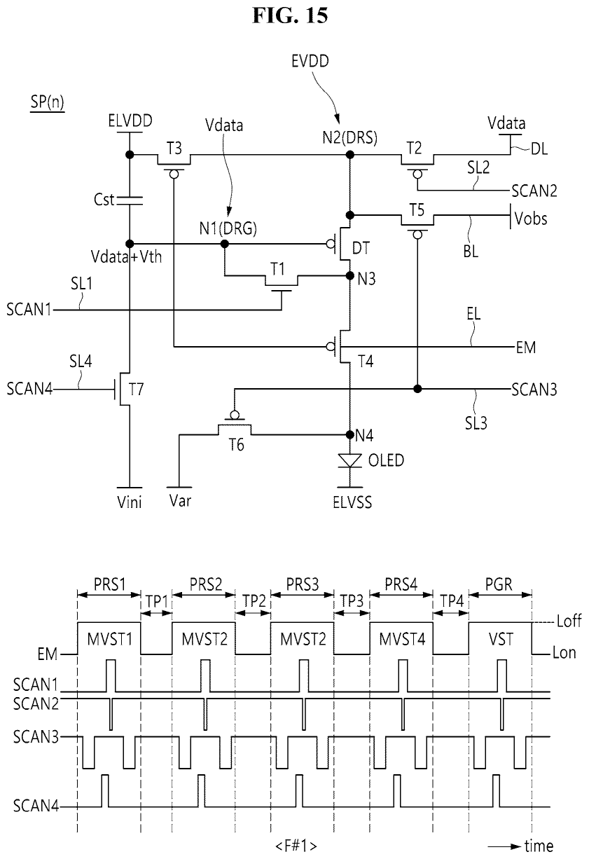

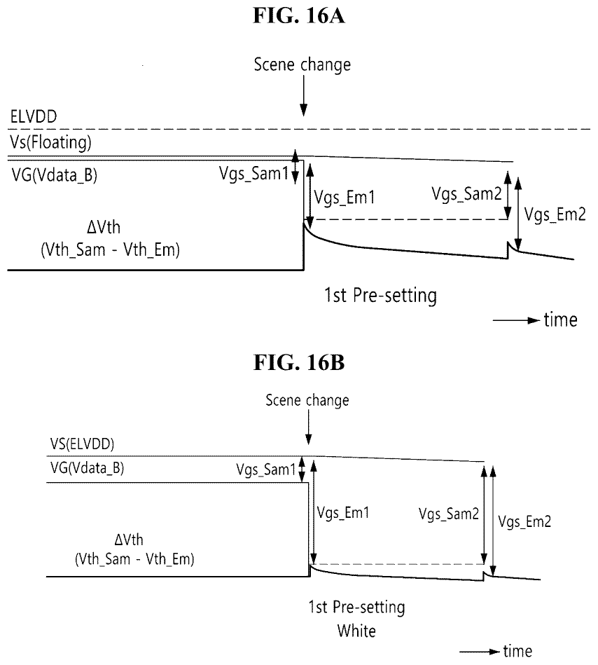

FIG. 14 is a diagram illustrating multi pre-setting driving decoupled from EM ON driving. FIG. 15 is a diagram illustrating multi pre-setting driving coupled to EM ON driving. FIGS. 16A and 16B are diagrams illustrating ΔVth variation with respect to FIGS. 14 and 15.

Referring to FIG. 14, MVST decoupled from EM ON driving may be implemented in a first refresh frame F #1 immediately after a scene change (for example, black image to white image).

The first refresh frame F #1 of FIG. 14 may include a first pre-setting period PRS1 where pre-setting data is written in a target pixel for a first time, a second pre-setting period PRS2 where the pre-setting data is written in the target pixel for a second time, and a programming period PGR where the target data is written in the target pixel. Also, as illustrated in FIG. 14, the first refresh frame F #1 of FIG. 14 may further include a third pre-setting period PRS3 and a fourth pre-setting period PRS4 between the second pre-setting period PRS2 and the programming period PGR.

An emission control signal EM for controlling an emission timing of the target pixel may have an off level Loff in the first pre-setting period PRS1, the second pre-setting period PRS2, the programming period PGR, a first transition period TP1 between the first pre-setting period PRS1 and the second pre-setting period PRS2, and a second transition period TP2 between the second pre-setting period PRS2 and the programming period PGR. That is, the emission control signal EM may have the off level Loff in all of an MVST period and a VST period of the first refresh frame F #1.

An electrical connection between a source electrode of a driving transistor included in the target pixel and a high-level pixel power source may be disabled in the first pre-setting period PRS1, the second pre-setting period PRS2, the programming period PGR, the first transition period TP1, and the second transition period TP2, based on the emission control signal EM of the off level Loff. As a result, a source electrode DRS of a driving transistor DT included in the target pixel may be floated, and a Vgs of the driving transistor DT may be “VG(Vdata+Vth)−VS(Float)”. Such a Vgs may have a difference with “VG(Vdata+Vth)−VS(ELVDD)” under a real driving condition. Accordingly, as shown in FIG. 16A, a Vth difference ΔVth between a threshold voltage sampling time and an OLED emission time may be relatively large, and the number of MVSTs for Vth stabilization may increase.

Moreover, referring to FIG. 15, MVST coupled to EM ON driving may be implemented in a first refresh frame F #1 immediately after a scene change (for example, black image to white image).

The first refresh frame F #1 of FIG. 15 may include a first pre-setting period PRS1 where pre-setting data is written in a target pixel for a first time, a second pre-setting period PRS2 where the pre-setting data is written in the target pixel for a second time, and a programming period PGR where the target data is written in the target pixel. Also, as illustrated in FIG. 15, the first refresh frame F #1 may further include a third pre-setting period PRS3 and a fourth pre-setting period PRS4 between the second pre-setting period PRS2 and the programming period PGR.

An emission control signal EM for controlling an emission timing of the target pixel may have an off level Loff in the first pre-setting period PRS1, the second pre-setting period PRS2, and the programming period PGR and may have an on level Lon in a first transition period TP1 between the first pre-setting period PRS1 and the second pre-setting period PRS2 and a second transition period TP2 between the second pre-setting period PRS2 and the programming period PGR. That is, the emission control signal EM may alternately have the on level Lon and the off level Loff in an MVST period and a VST period of the first refresh frame F #1 a plurality of times.

An electrical connection between a source electrode of a driving transistor included in the target pixel and a high-level pixel power source may be disabled in the first pre-setting period PRS1, the second pre-setting period PRS2, and the programming period PGR, based on the emission control signal EM of the off level Loff, and may be enabled in the first transition period TP1 and the second transition period TP2, based on the emission control signal EM of the on level Lon. In an EM ON state, a Vgs of a driving transistor DT may be “VG(Vdata+Vth)−VS(ELVDD)” which is the same as a real driving condition. As a result, as in FIG. 16B, a Vth difference ΔVth between a threshold voltage sampling time and an OLED emission time may be relatively small, and the number of MVSTs for Vth stabilization may decrease.

FIGS. 17 to 19 are diagrams illustrating MVST coupled to Vini swing driving.

Referring to FIGS. 17 to 19, a gate electrode DRG of a driving transistor DT may be reset by an initialization voltage Vini during the pre-OBS period xx and the initialization period Ti of FIG. 4.

The initialization voltage Vini according to an embodiment of the present disclosure may be implemented at an alternating current (AC) level unlike a direct current (DC) level of FIG. 10. The initialization voltage Vini may have a first level L1 in a first refresh frame F #1 and may have a second level L2, which is greater than the first level L1, in the other refresh frames F #2 and F #3 except the first refresh frame F #1 and skip frames F #4 to F #120.

When the initialization voltage Vini is relatively reduced in the first refresh frame F #1, Vgs may increase during the pre-OBS period xx. Accordingly, a Vth difference ΔVth between a threshold voltage sampling time and an OLED emission time may decrease, and thus, a middle peak luminance may be improved toward an increase.

Therefore, in an embodiment of the present disclosure, comparing with MVST of FIG. 10 which is decoupled from the Vini swing driving, the number of refresh frames for multi-refresh driving may be more decreased (decreased by two compared to four frames of FIG. 10). As a result, a peak luminance may be improved, and an increase in power consumption caused by multi-refresh driving may be minimized.

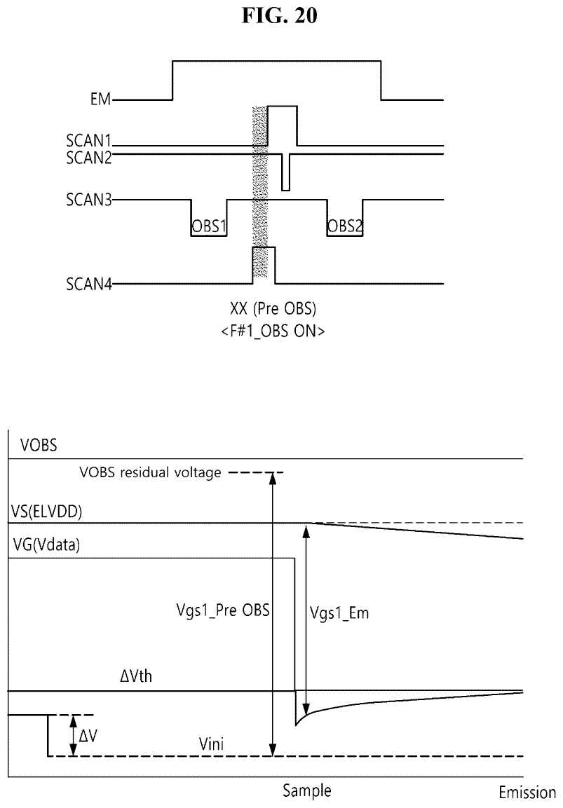

FIG. 20 is a diagram illustrating MVST coupled to OBS ON driving.

Referring to FIG. 20, a first refresh frame F #1 may further include a first OBS period OBS1 preceding a supply timing xx of an initialization voltage Vini and a second OBS period OBS2 succeeding the supply timing xx of the initialization voltage Vini.

An electrical connection between an OBS power source Vobs and a source electrode DRS of a driving transistor DT may be enabled in the first OBS period OBS1 and the second OBS period OBS2 and may be disabled in the other period, except the first OBS period OBS1 and the second OBS period OBS2, of the first refresh frame F #1.

When OBS ON driving is performed, an OBS voltage VOBS may be supplied to the source electrode DRS of the driving transistor DT, and thus, a source voltage VS of the driving transistor DT immediately before a pre-OBS period xx may be a VOBS residual voltage.

When OBS ON driving is performed in a state where the initialization voltage Vini is decreased by a certain level ΔV, a Vgs of the pre-OBS period xx may excessively increase. In this case, ΔVth may also increase, and thus, luminance may increase.

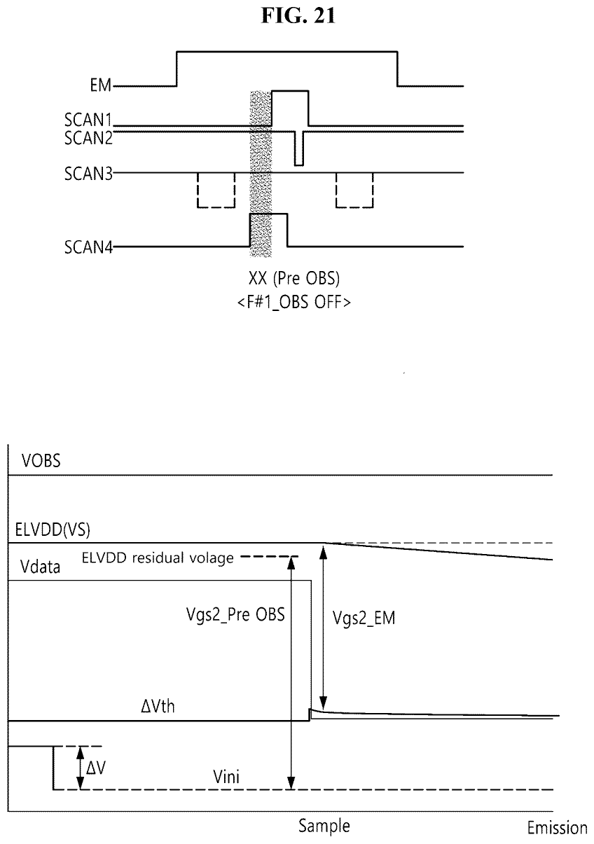

FIG. 21 is a diagram illustrating MVST coupled to OBS OFF driving.

Referring to FIG. 21, a first refresh frame F #1 may further include a first OBS period OBS1 preceding a supply timing xx of an initialization voltage Vini and a second OBS period OBS2 succeeding the supply timing xx of the initialization voltage Vini.

An electrical connection between an OBS power source Vobs and a source electrode DRS of a driving transistor DT may be disabled in all periods, including the first OBS period OBS1 and the second OBS period OBS2, of the first refresh frame F #1.

When OBS OFF driving is performed, a source voltage VS of the driving transistor DT immediately before a pre-OBS period xx may be an ELVDD residual voltage.

When OBS OFF driving is performed in a state where the initialization voltage Vini decreases by a certain level ΔV, an OBS voltage VOBS may not be applied to the source electrode DRS of the driving transistor DT, and thus, a side effect may be prevented where a Vgs of the pre-OBS period xx excessively increases, and ΔVth increases also.

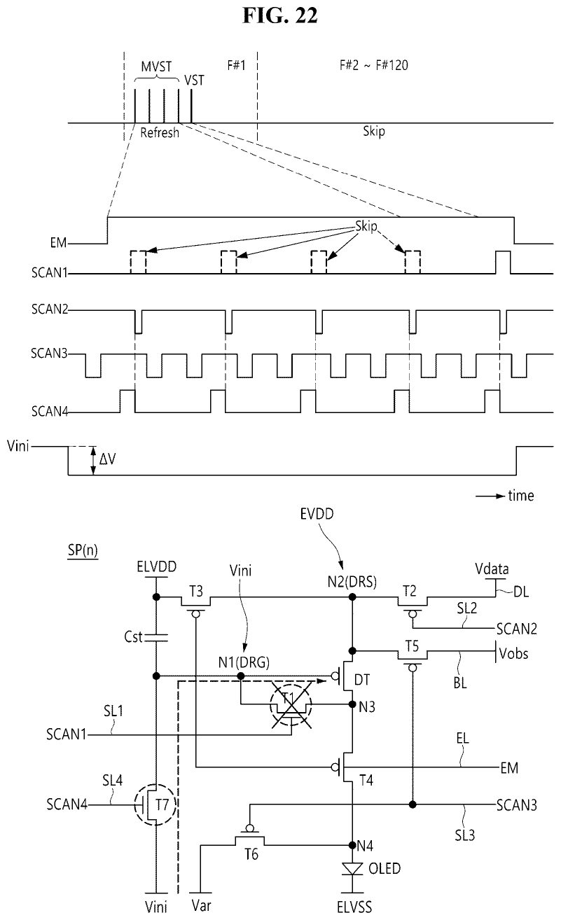

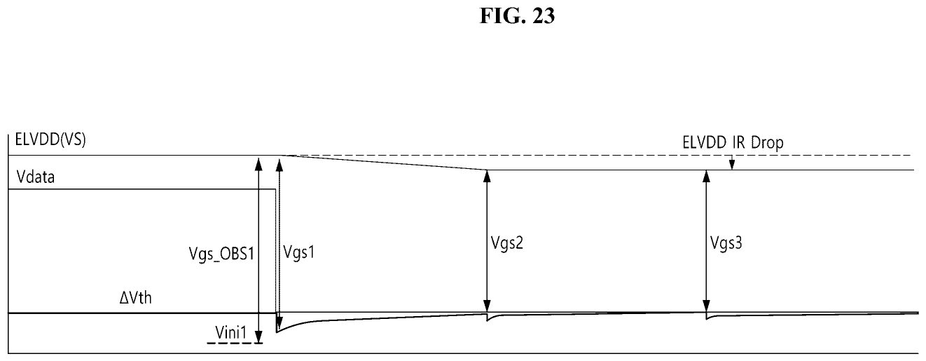

FIGS. 22 and 23 are diagrams illustrating multi pre-setting driving requiring no parallel with multi-refresh driving.

Referring to FIGS. 22 and 23, when performing a scene change from a previous image to a target image, a display panel driver may write target data, which is for implementing a target image, in a target pixel during a refresh frame F #1, and then, the target pixel may hold the target data during a plurality of skip frames F #2 to F #120.

In the refresh frame F #1, an initialization voltage Vini for a reset operation may be first applied to the target pixel repeatedly a plurality of times before the target data is written in the target pixel. The initialization voltage Vini may be a certain level ΔV lower in the refresh frame F #1 than in the skip frames F #2 to F #120.

In the refresh frame F #1, a gate electrode DRG of the driving transistor DT included in the target pixel may be reset by the initialization voltage Vini repeatedly a plurality of times. To this end, in an MVST period, SCAN4 may repeat on/off a plurality of times equal to the number of MVSTs, and SCAN1 may maintain an off state.

MVST according to an embodiment of the present disclosure, unlike the embodiments described above, may repeatedly apply the initialization voltage Vini to the target pixel, and thus, may implement luminance overshoot driving and ΔVth inversion driving. As a result, a middle peak luminance increase width and a Vgs increase width may be large in MVST. Accordingly, in an embodiment of the present disclosure, because ΔVth may be quickly reduced even without parallel with multi-refresh driving, an increase in power consumption caused by multi-refresh driving may be prevented.

The present disclosure may realize the following effects.

The present disclosure may improve a flicker characteristic and may also minimize an increase in power consumption.

The effects according to the present disclosure are not limited to the above examples, and other various effects may be included in the specification.

It will be apparent to those skilled in the art that various modifications and variations can be made in the display device and the driving method thereof of the present disclosure without departing from the technical idea or scope of the disclosure. Thus, it is intended that the present disclosure cover the modifications and variations of this disclosure provided they come within the scope of the appended claims and their equivalents.

What is claimed is:

1. A display device comprising:
a display panel including one or more pixels; and
a display panel driver configured to, when performing a scene change from a previous image to a target image, repeatedly write target data, which is for implementing the target image, in a target pixel during a plurality of refresh frames continuously arranged, and then, hold the target data in the target pixel during a plurality of skip frames,
wherein, in a first refresh frame immediately after the scene change among the plurality of refresh frames, pre-setting data corresponding to the target data is written in the target pixel a plurality of times before the target data is written in the target pixel.

2. The display device of claim 1, wherein the pre-setting data is target data of each of pre-charging pixels driven prior to the target pixel in the first refresh frame.

3. The display device of claim 1, wherein the first refresh frame comprises:
a first pre-setting period where the pre-setting data is written in the target pixel for a first time;
a second pre-setting period where the pre-setting data is written in the target pixel for a second time; and
a programming period where the target data is written in the target pixel,
wherein an emission control signal for controlling an emission timing of the target pixel has an off level in the first pre-setting period, the second pre-setting period, the programming period, a first transition period between the first pre-setting period and the second pre-setting period, and a second transition period between the second pre-setting period and the programming period, and
wherein an electrical connection between a source electrode of a driving transistor included in the target pixel and a high-level pixel power source is disabled in the first pre-setting period, the second pre-setting period, the programming period, the first transition period, and the second transition period, based on the emission control signal of the off level.

4. The display device of claim 1, wherein the first refresh frame comprises:
a first pre-setting period where the pre-setting data is written in the target pixel for a first time;
a second pre-setting period where the pre-setting data is written in the target pixel for a second time; and
a programming period where the target data is written in the target pixel,
wherein an emission control signal for controlling an emission timing of the target pixel has an off level in the first pre-setting period, the second pre-setting period, and the programming period and has an on level in a first transition period between the first pre-setting period and the second pre-setting period and a second transition period between the second pre-setting period and the programming period, and
wherein an electrical connection between a source electrode of a driving transistor included in the target pixel and a high-level pixel power source is disabled in the first pre-setting period, the second pre-setting period, and the programming period, based on the emission control signal of the off level, and is enabled in the first transition period and the second transition period, based on the emission control signal of the on level.

5. The display device of claim 4, wherein a gate electrode of the driving transistor is reset by an initialization voltage, and
wherein the initialization voltage has a first level in the first refresh frame and has a second level, which is higher than the first level, in the plurality of skip frames and the other refresh frames except the first refresh frame.

6. The display device of claim 4, wherein a gate electrode of the driving transistor is reset by an initialization voltage, and
wherein the initialization voltage has a first level in each of the plurality of refresh frames and has a second level, which is higher than the first level, in the plurality of skip frames.

7. The display device of claim 5, wherein the first refresh frame further comprises a first on-bias stress (OBS) period preceding a supply timing of the initialization voltage and a second OBS period succeeding the supply timing of the initialization voltage, and
wherein an electrical connection between an OBS power source and the source electrode of the driving transistor is enabled in the first OBS period and the second OBS period and is disabled in the other period, except the first OBS period and the second OBS period, of the first refresh frame.

8. The display device of claim 5, wherein the first refresh frame further comprises a first on-bias stress (OBS) period preceding a supply timing of the initialization voltage and a second OBS period succeeding the supply timing of the initialization voltage, and
wherein an electrical connection between an OBS power source and the source electrode of the driving transistor is disabled in all periods, including the first OBS period and the second OBS period, of the first refresh frame.

9. A display device comprising:
a display panel including one or more pixels; and
a display panel driver configured to, when performing a scene change from a previous image to a target image, write target data, which is for implementing the target image, in a target pixel during a refresh frame, and then, hold the target data in the target pixel during a plurality of skip frames,
wherein an initialization voltage for a reset operation is applied to the target pixel a plurality of times before the target data is written in the target pixel, in the refresh frame.

10. The display device of claim 9, wherein a gate electrode of a driving transistor included in the target pixel is reset by the initialization voltage a plurality of times, in the refresh frame.

11. The display device of claim 9, wherein the initialization voltage has a first level in the refresh frame and has a second level, which is higher than the first level, in the plurality of skip frames.

12. A driving method of a display device including a display panel including one or more pixels, the driving method comprising:
when performing a scene change from a previous image to a target image, repeatedly writing target data, which is for implementing the target image, in a target pixel during a plurality of refresh frames continuously arranged; and
holding the target data in the target pixel during a plurality of skip frames,
wherein, in a first refresh frame immediately after the scene change among the plurality of refresh frames, pre-setting data corresponding to the target data is written in the target pixel a plurality of times before the target data is written in the target pixel.

13. A driving method of a display device including a display panel including one or more pixels, the driving method comprising:
when performing a scene change from a previous image to a target image, writing target data, which is for implementing the target image, in a target pixel during a refresh frame; and
holding the target data in the target pixel during a plurality of skip frames,
wherein an initialization voltage for a reset operation is applied to the target pixel a plurality of times before the target data is written in the target pixel, in the refresh frame.

14. A pixel circuit comprising:
a driving transistor comprising a gate electrode connected to a first node, a first electrode connected to a second node, and a second electrode connected to a third node;
a first switching transistor comprising a first electrode connected to the first node, a second electrode connected to the third node, and a gate electrode receiving a first scan signal;
a second switching transistor comprising a first electrode receiving data voltage, a second electrode connected to the second node, and a gate electrode receiving a second scan signal;
a third switching transistor comprising a first electrode connected to a first power source voltage, a second electrode connected to the second node, and a gate electrode receiving an emission control signal;
a fourth switching transistor comprising a first electrode connected to the third node, a second electrode connected to a fourth node, and a gate electrode receiving the emission control signal;
a fifth switching transistor comprising a first electrode receiving an on bias stress (OBS) voltage, a second electrode connected to the second node, and a gate electrode receiving a third scan signal;
a sixth switching transistor comprising a first electrode receiving an anode reset voltage, a second electrode connected to the fourth node, and a gate electrode receiving the third scan signal;
a seventh switching transistor comprising a first electrode receiving an initialization voltage, a second electrode connected to the first node, and a gate electrode receiving a fourth scan signal;
a capacitor connected between the first node and the first power source voltage; and
a light emitting element comprising an anode electrode connected to the fourth node and a cathode electrode connected to a second power source voltage.

15. The pixel circuit according to claim 14, wherein the second switching transistor, the third switching transistor, the fourth switching transistor, the fifth switching transistor, and the sixth switching transistor are PMOS transistors, and the first switching transistor and the seventh switching transistor are NMOS transistors.

16. The pixel circuit according to claim 15, wherein the PMOS transistor comprises a low-temperature polycrystalline silicon semiconductor layer, and the NMOS transistor comprises an oxide semiconductor layer.
